(19) United States
(12) Patent Application Publication
(10) Pub. No.: US 2007/0166584 A1
(43) Pub. Date: Jul. 19, 2007

(54) FUEL CELL SYSTEM AND ELECTRIC VEHICLE HAVING THE SYSTEM

(76) Inventor: Atsushi Kurosawa, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/622,972

(22) Filed: Jan. 12, 2007

(30) Foreign Application Priority Data
Jan. 12, 2006 (JP) 2006-004745

(51) Int. Cl. H01M 8/04

(52) U.S. Cl. 429/22; 429/34; 429/23; 429/25; 429/17

(57) ABSTRACT

A fuel cell system includes a fuel cell that generates electric power via the reaction of hydrogen gas supplied by a hydrogen cylinder with oxygen gas supplied by an air blower. The electric power generated by the fuel cell is used to operate a drive motor and charge a secondary battery. The system also includes a power supply system control device and a gas recirculation line for returning unreacted hydrogen gas discharged from the fuel cell to the gas delivery line that supplies hydrogen gas to the fuel cell. A main shutoff valve is positioned in the gas delivery line to selectively allow flow of hydrogen gas therethrough. Also, a connector is positioned between a junction of the gas delivery line with the gas recirculation line and the main shutoff valve so that the hydrogen cylinder can be selectively coupled to and decoupled from the fuel cell. The system can be operated so that the hydrogen cylinder, which may contain residual hydrogen gas, can be exchanged without releasing the hydrogen gas to the atmosphere.

### CROSS-REFERENCE TO RELATED APPLICATIONS

The present application is based on and claims priority under 35 U.S.C. § 119 to Japanese Patent Application No. 2006-004745, filed on Jan. 12, 2006, the entire contents of which is expressly incorporated by reference herein.

### BACKGROUND OF THE INVENTION

1. Field of the Invention

The present invention relates to a fuel cell system including a fuel cell and a secondary battery and also relates to an electric vehicle having the fuel cell system.

2. Description of the Related Art

Conventionally, some vehicles run using electric power generated by a fuel cell. Such vehicles include motorcycles and electric bicycles that use the electric power generated by the fuel cell as the primary or auxiliary power for operation, as discussed, for example, in Japanese Publication No. 8-119180. In JP 8-119180, the electric bicycle has a hydrogen cylinder and a fuel cell connected to each other through a conduit having a valve. By opening the valve, hydrogen gas can be supplied to the fuel cell. Also, the electric bicycle has a fan that pressurizes outside air that is directed to the fuel cell. Oxygen in the pressurized air reacts with the hydrogen gas in the fuel cell to generate electric power. When the hydrogen in the hydrogen cylinder is exhausted, the empty hydrogen cylinder is replaced with a new hydrogen cylinder.

However, in the conventional electric bicycle described above, if residual hydrogen gas resides within the hydrogen cylinder or within the conduit when the hydrogen cylinder is replaced with the new hydrogen cylinder, the residual hydrogen gas may be discharged outside. Therefore, all of the hydrogen gas in the cylinder is not used for generating electric power so that some of the hydrogen gas is wasted. In order to avoid the waste of hydrogen gas, the hydrogen gases within the hydrogen cylinder need to be completely exhausted. This can reduce the number of times the hydrogen cylinder needs to be replaced.

### SUMMARY OF THE INVENTION

In view of the circumstances noted above, an aspect of at least one of the embodiments disclosed herein is to provide a fuel cell system whose hydrogen cylinder can be exchanged without residual hydrogen gas in the cylinder being discharged outside the cylinder.

In accordance with one aspect of the present invention, a fuel cell system is provided. The fuel cell system comprises a fuel cell configured to react hydrogen gas with oxygen gas to generate electric power, the hydrogen gas supplied from a hydrogen cylinder through a hydrogen supply line. The fuel cell system also comprises an operating device configured to operate using electric power generated at least in part by the fuel cell. A secondary power storage device is operatively connected to the fuel cell, the secondary power storage device charged with electric power generated at least in part by the fuel cell. A recirculation line is coupled to the hydrogen supply line at a junction and coupled to the fuel cell, the recirculation line configured to return unreacted hydrogen gas discharged by the fuel cell back to the fuel cell via the hydrogen supply line. The fuel cell system also comprises a power supply system control device. A valve is disposed upstream of the junction between the recirculation line and the hydrogen supply line. The valve is controlled by the power supply system control device and is selectively moveable to an open position to allow flow of hydrogen gas from the hydrogen gas cylinder to the fuel cell. The valve is further selectively moveable to a closed position to allow decoupling of the hydrogen cylinder from the hydrogen supply line. The recirculation line directs unreacted hydrogen gas therein to the fuel cell to exhaust said unreacted hydrogen gas and further generate electric power with the valve in the closed position

In accordance with another aspect of the present invention, a fuel cell system is provided comprising a fuel cell configured to react hydrogen gas with oxygen gas to generate electricity. The fuel cell system also comprises an electric motor configured to operate using electric power generated at least in part by the fuel cell. A secondary power storage device is electrically connected to the fuel cell and to the electric motor. The secondary power storage device is charged with electric power generated at least in part by the fuel cell. The fuel cell system also comprises means for inhibiting release of unreacted hydrogen gas when a hydrogen supply device operatively coupled to the fuel cell is decoupled therefrom.

In accordance with another aspect of the present invention, a method for operating a fuel cell system having a fuel cell coupled to a secondary power storage device is provided. The method comprises reacting hydrogen gas with oxygen gas within the fuel cell to generate electric power. The method further comprises recirculating unreacted hydrogen gas discharged from the fuel cell back to the fuel cell to generate additional electric power. The method also comprises selectively isolating a hydrogen supply tank from the fuel cell to allow replacement of the tank while inhibiting release of unreacted hydrogen gas from the fuel cell system.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 4 figures.

FIG. 1 is a side elevational schematic view of a motorcycle having one embodiment of a fuel cell system.

FIG. 2 is a block diagram of one embodiment of the fuel cell supply system.

FIG. 3 is a flowchart showing a program that makes a fuel cell generate electric power for one embodiment of a fuel cell system.

FIG. 4 is a flowchart showing another program that operates a fuel cell to generate electric power in accordance with another embodiment of a fuel cell system.

### DETAILED DESCRIPTION OF THE PREFERRED EMBODIMENT

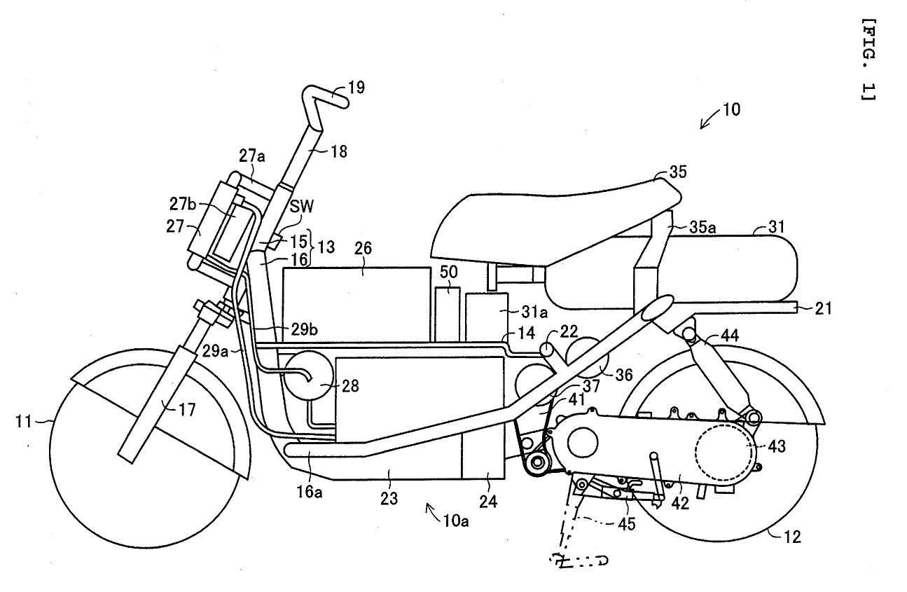

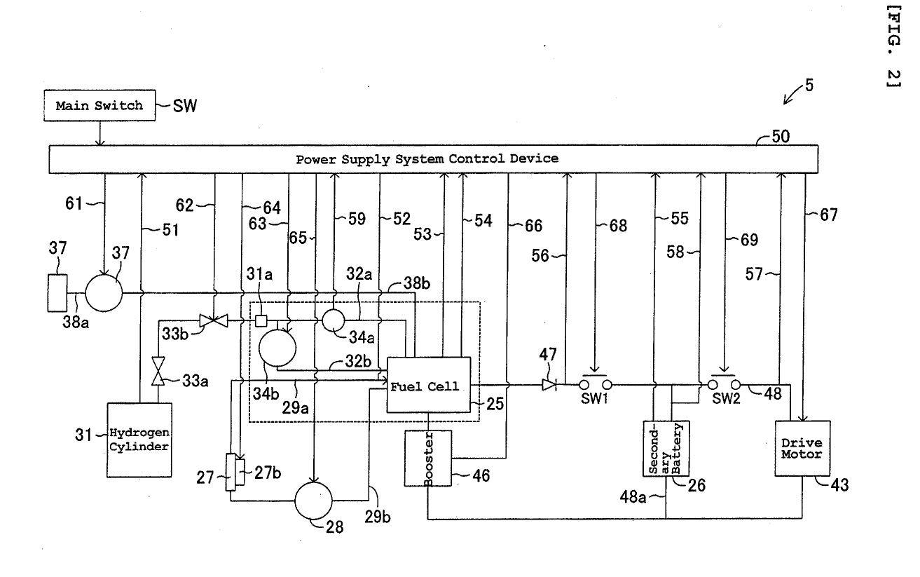

FIG. 1 shows a motorcycle 10 having a fuel cell system (see FIG. 2) in accordance with one preferred embodiment of the invention. The motorcycle 10 includes a pair of wheels, which are a front wheel 11 and a rear wheel 12, and a vehicle body 10a to which the pair of wheels are attached. The vehicle body 10a includes a vehicle body frame 13 forming the major part of the vehicle body 10a and a sub frame 14 detachably mounted to the vehicle body frame 13. The vehicle body frame 13 includes a head pipe 15 forming a front portion of the vehicle body 10a and a down tube 16 extending rearward from the head pipe 15. The shape of the motorcycle 10 is not limited to that shown in FIG. 1, nor are other conditions of the vehicle limited thereto. Additionally, the inventions disclosed herein are not limited to a so-called motorcycle-type two-wheel vehicle, but are applicable to other types of two-wheel vehicles. Moreover, the inventions disclosed herein are not limited to two-wheel vehicles, but may be used with other types of saddle-type vehicle. Furthermore, the inventions disclosed herein are not limited to saddle-type vehicles, but can also be used with other types of vehicles such as four-wheel buggy for two riders.

The front wheel 11 is rotatably supported at the lower end of a front fork 17 whose lower portion is bifurcated. That is, the lower ends of the front fork 17 support the central shaft (not shown) of the front wheel 11 to allow rotation of the wheel 11 about the shaft. The bottom end of a steering shaft 18 disposed within the head pipe 15 is coupled with a top end of the front fork 17. The steering shaft 18 is inserted into the head pipe 15 so that the steering shaft 18 is pivotable about an axis of the head pipe 15. The top portion of the steering shaft 18 protrudes upwardly from the head pipe 15.

Handle bars 19 extending generally horizontally are coupled with the top portion of the steering shaft 18. Therefore, when the handle bars 19 are pivoted about an axis of the steering shaft 18, the front wheel 11 changes its direction rightward or leftward about an axis of the front fork 17 in accordance with a pivotal amount of the steering shaft 18. Each of right and left ends of the handle bars has a grip (not shown), which can be grasped by a user's hand.

One of the grips is attached for pivotal movement about an axis thereof and defines an accelerator for adjusting the drive power of a drive motor 43 (discussed further below). The other grip is fixed to the handle bars 19. Brake levers (not shown) are disposed adjacent to the respective grips. The brake levers are urged to be spaced apart from the respective grips, and restrain the rotations of the front wheel 11 and the rear wheel 12 by being pulled toward the grips.

The down tube 16 includes a pair of main frames 16a (only one of them is shown) which extend downwardly and rearwardly from the junction with the head pipe 15, while widening the distance therebetween. Further, rear portions of the respective main frames 16a extend obliquely rearward and upward while keeping a substantially constant distance therebetween. Rear ends of the respective main frames 16a are coupled with a plate-like attaching member 21 that extends horizontally.

With continued reference to FIG. 1, a cross member 22 extends between top surfaces of the rear portions of the respective main frames 16a. Each end portion of the cross member 22 generally turns at substantially a right angle to configure a generally C-shaped bar. The ends of the cross member 22 are coupled with the respective main frames 16a so that a body portion protrudes upward from both of the main frames 16a. A positioning base 23 extends between bottom ends of the respective main frames 16a and protrudes downward therefrom. The top surface of the positioning base 23 can be formed as a recess, which receives a fuel cell container 24 therein. A fuel cell 25 (see FIG. 2) is contained in the interior of the fuel cell container 24.

The sub frame 14, which has a plate-like shape, is mounted between the down tube 16 and the cross member 22. A secondary power storage device 26 is fixed to the top surface of the sub frame 14 at a location slightly forward of the center portion of the sub frame 14. As used herein, “secondary power storage device” means a power storage device (e.g., a battery) coupled to an operating device (e.g., an electric motor) to supplement power from a primary power supply (e.g., a fuel cell). In the illustrated embodiment, the secondary power storage device 26 is a secondary battery 26, which can be a lithium ion battery. A power supply system control device 50 for controlling respective devices provided to the fuel cell system S can be fixed to a top surface of the sub frame 14, and is positioned between the secondary battery 26 and the cross member 22 in the illustrated embodiment.

A radiator 27 is attached to a front portion of the head pipe 15 via attaching members 27a. A fan 27b for air-cooling the radiator is attached to a rear side of the radiator 27 (between the radiator 27 and the head pipe 15). A water pump 28 is positioned between the fuel cell container 24 and the down tube 16, and also below the sub frame 14 (the secondary battery 26). The radiator 27 and the fuel cell 25 are connected to each other by a cooling water delivery line 29a, which can be a pipe, through which cooling water flows from the fuel cell 25 to the radiator 27. The cooling water delivery line 29a extends from the fuel cell 25 to the radiator 27, running along the down tube 16 and below the sub frame 14.

Another cooling water delivery line 29b extends from the radiator 27 to the water pump 28 through which the cooling water flows from the radiator 27 to the fuel cell 25. The cooling water delivery line 29b further extends from the water pump 28 to the fuel cell 25 through a front surface of the fuel cell container 24. Thus, the operation of the water pump 28 provides coolant from the radiator 27 to the fuel cell 25 by way of the cooling water delivery line 29b to cool the fuel cell 25. After absorbing the heat while cooling down the fuel-cell system 25, the cooling water can be returned to the radiator 27 by way of the cooling water line 29a and can be cooled down by the fan 27b while passing through the radiator 27.

With continued reference to FIG. 1, a hydrogen cylinder 31 which can be filled with hydrogen to be supplied to the fuel cell 25 can be attached to a top surface of an attaching member 21 coupled with rear end portions of the respective main frames 16a. The hydrogen cylinder 31 is connected to the fuel cell 25 through a connector 31a which functions as an attaching and detaching device. As shown in FIG. 2, the hydrogen cylinder 31 can be coupled to a hydrogen gas supply port of the fuel cell 25 through a gas delivery line 32a which functions as a hydrogen supply delivery line. In the illustrated embodiment, the connector 31a is positioned in the gas delivery line 32a. Also, a hydrogen gas discharge port of the fuel cell 25 is coupled to a downstream portion of the gas delivery line 32a located adjacent but farther downstream of the connector 31a through a gas delivery line 32b which functions as a recirculation delivery line 32b.

A primary valve 33a can be positioned along a portion of the gas delivery line 32a proximal the hydrogen cylinder 31. The valve 33a can be manually opened or closed to allow flow of hydrogen gas through the gas delivery line 32 a from the hydrogen cylinder 31. A main shutoff valve 33b is positioned at along another portion of the gas delivery line 32a located downstream of the valve 33a. A pressure sensor 34a measures a pressure of the hydrogen gases within the gas delivery line 32a. The pressure sensor 34a is positioned along the gas delivery line 32a downstream of the junction with the gas delivery line 32b. A recirculation pump 34b is positioned along the recirculation delivery line 32b for returning the hydrogen gases discharged from the hydrogen gas discharge port of the fuel cell 25 to the gas delivery line 32a.

Therefore, by bringing the primary valve 33a and the main shutoff valve 33b to their opening positions, the hydrogen gas within the hydrogen cylinder 31 can be supplied to the fuel cell 25 through the gas delivery line 32a. Also, by operating the recirculation pump 34b, hydrogen gas in the fuel cell 31 that has not reacted with oxygen can be returned to the gas delivery line 32a through the gas delivery line 32b so as to be joined with the hydrogen gas flowing through the gas delivery line 32a from the hydrogen cylinder 31. The hydrogen gas circulates through the gas deliver lines 32a, 32b until it reacts with the oxygen in the fuel cell 25.

As shown in FIG. 1, a seat 35 is disposed above a front section of the hydrogen cylinder 31. The seat 35 is coupled with the rear portions of the respective main frames 16a via support members 35a.

An air filter 36 can be installed rearwardly of the cross member 22 and attached to the rear portions of the main frames 16a. An air blower 37 can be installed forwardly of the cross member 22 and likewise attached to the rear portions of the main frames 16a. Additionally, positioning bases (not shown) are disposed between the respective main frames 16a in the rear portions of the main frames 16a. The air filter 36 and the air blower 37 are fixed to the down tube 16 via the positioning bases.

The air filter 36 and the air blower 37, as well as the air blower 37 and the fuel cell 25, are connected to each other through gas delivery lines 38a, 38b, respectively (see FIG. 2). Outside air is sucked in by the air blower 37 through the air filter 36 and introduced into the fuel cell 25. Foreign substances in the outside air are removed as the air passes through the air filter 36. The air filter 36 and the air blower 37 together form an oxygen supply device. A rear arm (not shown) formed with a pair of rearward-extending arm members is coupled with lower sections of the rear portions of the respective main frames 16a through a coupling unit 41.

Rear end portions of the respective arm members of the rear arm rotatably support lateral side portions of a center shaft of the rear wheel 12; thereby, the rear wheel 12 is rotatable about an axis of the center shaft. A motor unit 42 is mounted to an outer surface of one of the arm members of the rear arm in such a manner that the motor unit 42 covers the arm member. The motor unit 42 accommodates a drive motor 43, which can be an electric motor that operates with the electricity generated by the fuel cell 25, and reduction gears. The operation of the drive motor 43 rotates the rear wheel 12 to propel the motorcycle 10.

Shock absorbers 44 can be placed across the rear ends of the down tube 16 and the upper rear ends of the rear arm, respectively. The rear ends of the rear arm can be structured to allow a swinging motion of the arm via the telescopic movement of the shock absorbers 44. A drum brake (not shown) can be attached to an inner surface of the motor unit 42. The drive motor 43 can operate in proportion to the degree the grip in the handlebar 19 is turned under the control of a controller 50 (power supply system control device), to automatically generate the driving force on the rear wheel 12.

With continued reference to FIG. 1, this motorcycle 10 can be provided with a rotary stand 45 for keeping the motorcycle 10 in an upright position when the motorcycle 10 is stopped. The stand 45 can be raised when the motorcycle 10 runs as indicated by the solid line of FIG. 1, while the stand 45 can be lowered to support the motorcycle 10 when the motorcycle 10 is stopped, as indicated by the chain double-dashed line of FIG. 1.

In the illustrated embodiment, the fuel cell system S includes a booster 46 for boosting voltage generated by the fuel cell 25, and a diode 47 for preventing current from flowing back to the fuel cell 25. The fuel cell 25, the secondary battery 26, the drive motor 43, the booster 46, the diode 47 and wiring that connects them to each other together form an electric circuit 48. An opening and closing switch SW1 that functions as a secondary battery switch is disposed between the fuel cell 25 and the secondary battery 26, while another opening and closing switch SW2 that functions as an operating device switch is disposed between the fuel cell 25 and the drive motor 43.

Although not shown, the respective devices forming the fuel cell system S can have various sensors for detecting various conditions of the devices. Electric wirings connect the sensors and the power supply system control device 50. That is, the hydrogen cylinder 31 can have a residual amount detecting sensor that detects a residual amount of hydrogen within the hydrogen cylinder 31. The cooling water delivery line 29a can have a temperature sensor that detects a temperature of the cooling water that is delivered from the radiator 27 to the fuel cell 25 and returned from the fuel cell 25 to the radiator 27 after cooling the fuel cell 25.

The fuel cell 25 has a temperature sensor that detects a temperature of the fuel cell 25 and a voltage sensor that detects an amount of voltage of the fuel cell 25. The secondary battery 26 also has a temperature sensor for detecting a temperature of the secondary battery 26. The electric circuit 48 has a current sensor for detecting an amount of current that flows through the electric circuit 48 and another current sensor for detecting an amount of current that flows through the drive motor 43 and an amount of voltage. The wiring 48a connected to the secondary battery 26 in the electric circuit 48 has an additional current sensor for detecting an amount of current that flows through the secondary battery 26.

The respective sensors are connected to the power supply system control device 50 through the respective wirings 51, 52, 53, 54, 55, 56, 57, 58 and can communicate thereby with the power supply system control device 50. However, in other embodiments, communication between the power supply control device 50 and the various sensors can be done via a wireless connection (e.g., Rf communication). The pressure sensor 34a and the power supply system control device 50 are connected to each other through a wiring 59. Additionally, the voltage sensor and the wiring 54 together form a voltage measuring device.

Wirings 61, 62, 63, 64, 65, 66, 67, 68, 69 connect the power supply system control device 50 to the air blower 37, the main shutoff valve 33b, the circulating pump 34, the fan 27b, the water pump 28, the booster 46, the drive motor 43, the opening and closing switch SW1 and the opening and closing switch SW2, respectively, for communicating signals from the power supply system control device 50 to these components. However, in other embodiments, communication between the power supply control device 50 and the various components (e.g., air blower 37, valve 33b, circulating pump 34, fan 27b, water pump 28, booster 46 and drive motor 43) can be done via a wireless connection (e.g., Rf communication). The air blower 37 operates in response to a flow amount command signal from the power supply system control device 50 to supply air to the fuel cell 25. The main shutoff valve 33b selectively moves to the opening position and the closing position thereof in response to an opening and closing command signal from the power supply system control device 50 to supply hydrogen gas from the hydrogen cylinder 31 to the fuel cell 25.

The fuel cell 25 makes the oxygen and hydrogen supplied by the air blower 37 and hydrogen cylinder 31, respectively, react with each other to generate electricity as well as water. The booster 46 boosts the electricity generated by the fuel cell 25 in response to a voltage command signal from the power supply system control device 50 to send the electricity to the drive motor 43, as well as to the secondary battery 26 to charge the secondary battery 26. The recirculation pump 34b operates in response to an operation command signal from the power supply system control device 50 to return the hydrogen gas that has not reacted with the oxygen in the fuel cell 25 to the gas delivery line 32a through the gas delivery line 32b so that the unreacted hydrogen gas can mix with the hydrogen gas flow being supplied though the gas delivery line 32a.

In one embodiment, the water pump 28 operates in response to an operation command signal from the power supply system control device 50 to circulate the cooling water between the radiator 27 and the fuel cell 25 to keep the temperature of the fuel cell 25 at a predetermined temperature. The fan 27b operates in response to an operation command signal from the power supply system control device 50 to direct airflow over the radiator 27 to cool the radiator. The drive motor 43 receives an operation signal generated in accordance with an operational amount of the accelerator, and operates in response to the operation signal.

The opening and closing switch SW1 can electrically connect and disconnect the fuel cell 25 to a point between the secondary battery 26 and the drive motor 43 in response to a corresponding opening and closing command signal received from the power supply system control device 50. Also, the opening and closing switch SW2 can electrically connect and disconnect the fuel cell 25 and the drive motor 43 in response to a corresponding opening and closing command signal from the power supply system control device 50. The secondary battery 26 is charged with electric power generated by the fuel cell 25 and provides auxiliary power to the drive motor 43, as needed.

The power supply system control device 50 can have a CPU, RAMs, ROMs, a timer and so forth. Various programs and data such as, for example, previously prepared maps can be stored into the ROMs. The CPU controls the drive motor 43, the main shutting valve 33b, the air blower 37, the water pump 28, etc. based upon the operation of the grip or the like by the rider or the programs, etc. that have been previously prepared. In addition, the motorcycle 10 has a power switch (not shown) for startup operation of the motorcycle 10 and a main switch SW.

In this construction, when the rider drives the motorcycle 10, the rider, first, straddles the seat 35 to sit thereon. Then, the rider operates the power switch and the main switch SW to bring them to the ON condition. Thereby, air is supplied from the air blower 37, and hydrogen is supplied from the hydrogen cylinder 31, to the fuel cell 25. The oxygen in the air and hydrogen react within the fuel cell 25 to generate electricity and produce water. The water pump 28 delivers cooling water from the radiator 27 to the fuel cell 25 so as to keep the fuel cell 25 at the predetermined temperature. Also, the fuel-cell system 25 releases the water generated by the reaction of oxygen with hydrogen into the environment along with the exhaust air (e.g., water vapor).

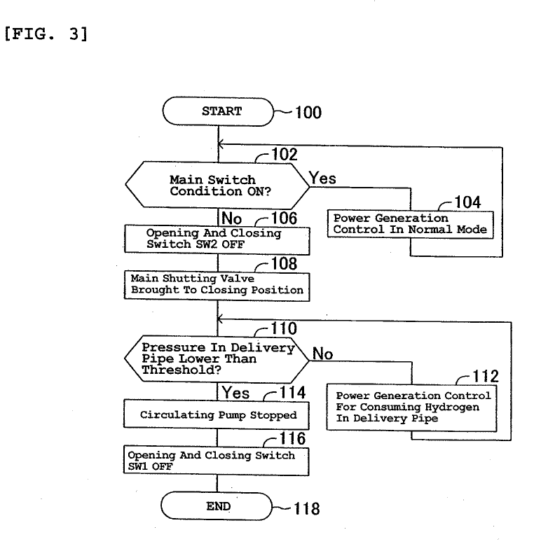

In one embodiment, the power supply system control device 50 executes the program shown by the flowchart of FIG. 3 to control power generation by the fuel cell 25. Such a program can be stored in the ROMs and be repeatedly executed at predetermined intervals by the CPU after the power switch is brought to the ON condition. The program first starts at a step 100 and goes to a step 102, to determine whether the main switch SW is in the ON condition. If the main switch SW is set to ON at this moment, the determination “YES” is made and the program goes to a step 104.

At step 104, power generation control is conducted in a normal mode. In this process, operation of the FC auxiliary devices (e.g., the air blower 37, the main shutoff valve 33b, the water pump 28, etc.) is controlled to make the fuel cell 25 generate electric power. This process can be executed by the CPU based upon an operational amount of the grip operated by the rider (e.g., torque or power request from the accelerator) and a preset map previously prepared and stored in the ROMs. Then, the program goes to the step 102 again to determine whether the main switch is in the ON state or not. If the main switch SW is not in the OFF state and remains in the ON state, the determination “YES” is made. The program goes to the step 104 to make the fuel cell 25 continue power generation.

The processes at the steps 102, 104 are repeated until the main switch SW is set to OFF and the determination “NO” is made at the step 102. During the intervening period, the fuel cell 25 is operated to generate electric power, and the drive motor 43 is operated using the generated electric power to operate the motorcycle 10. Also, during the period in which the processes are made, the motorcycle 10 repeats acceleration and deceleration in response to the operation of the grip. If the running speed of the motorcycle 10 needs to be lowered, the brake levers are operated in accordance with the necessity. Thereby, the motorcycle 10 reduces its speed in response to the operation amounts of the brake levers.

In order to bring the motorcycle 10 to a stop condition, the main switch SW is set to OFF and the determination “NO” is made at the step 102. The program thus goes to a step 106 to set the opening and closing switch SW2 to the OFF position, which stops the power supply from the fuel cell 25 to the drive motor 43. The program then goes to a step 108 to close the main shutoff valve 33b so that hydrogen gas supply from the hydrogen cylinder 31 to the fuel cell 25 is stopped. When the rider wants to finish driving the motorcycle 10, the rider pivots the stand 45 downward to make it touch the ground. Thereby, the motorcycle 10 stays in the upright position.

Next, the program goes to a step 110 to determine whether the pressure of the hydrogen gas within the gas delivery line 32a detected by the pressure sensor 34a is lower than the predetermined threshold value. This threshold pressure value can be previously set and stored in the RAMs. For example, the threshold can be set to atmospheric pressure. If the pressure in the gas delivery line 32a is higher than the threshold amount and the determination “NO” is made, the program goes to a step 112 to operate the fuel cell 25 to further generate electric power using hydrogen gas residing in the portion of the gas delivery line 32a downstream of the main shutoff valve 33b, which has been closed, and hydrogen gas also residing in the interior of the gas delivery line 32b. The electric power generated by the fuel cell 25 is directed to the secondary battery 26 to charge the secondary battery 26.

The program goes to step 110 to again determine whether the pressure of the hydrogen gas within the gas delivery line 32a is lower than the threshold or not. If the pressure of the hydrogen gas within the gas delivery line 32a is still higher than the threshold and the determination “NO” is made, the program goes to the step 112 to further operate the fuel cell 25 to generate electric power and charge the secondary battery 26, as described above. The processes at the steps 110, 112 are repeated until the pressure in the gas delivery line 32a decreases below the threshold pressure. During the intervening period, the generated power is used to charge the secondary battery 26 and the density of the hydrogen gas residing in the gas delivery line 32a downstream of the main shutoff valve 33b and in the gas delivery line 32b gradually becomes thinner.

When the pressure of the hydrogen gas within the gas delivery line 32a decreases below the threshold pressure and the determination “YES” is made, the program goes to a step 114. At step 114, the recirculation pump 34b is stopped to cease the circulation of hydrogen gas residing in the gas delivery line 32a downstream of the main shutoff valve 33b and in the interior of the gas delivery line 32b, as well as stop power generation by the fuel cell 25. The program then goes to a step 116 to set the opening and closing switch SW1 to OFF to thereby stop the charging of the secondary battery 26 with the electric power generated by the fuel cell 25.

The program then goes to a step 118 to end. When the operation of the fuel cell system S needs to be stopped, the power switch is brought to the OFF condition. Also, when the residual amount of the hydrogen gas within the hydrogen cylinder 31 decreases and the hydrogen cylinder 31 needs to be exchanged for a new hydrogen cylinder 31 filled with hydrogen gas, the connector 31a is detached with the primary valve 33a and the main shutoff valve 33b in the closed position.

The hydrogen cylinder 31 is detached from the attaching member 21, and the new hydrogen cylinder 31 is attached to the attaching member 21. Then, a connecting section of the hydrogen cylinder 31 is coupled with the connector 31a. Even though some hydrogen gas may reside within the hydrogen cylinder 31 that has been used, the hydrogen gas residing inside does not leak out of the cylinder 31 because the hydrogen cylinder 31 is closed by the primary valve 33a and the main shut-off valve 33b. Also, because no hydrogen gas resides in the gas delivery line 32a portion downstream of the main shutoff valve 33b and in the interior of the gas delivery line 32b, hydrogen gas does not leak even though the gas delivery line 32a is open.

As thus described, in the fuel cell system S of this embodiment, a downstream end of the gas delivery line 32b provided for returning hydrogen gas that has not reacted with the oxygen gas in the fuel cell 25 and has been discharged from the fuel cell 25 is joined with the portion of the gas delivery line 32a, which is provided for supplying hydrogen gas from the hydrogen cylinder 31 to the fuel cell 25, the portion being located downstream from the main shutoff valve 33b. Accordingly, by closing the main shutoff valve 33b, the anode closing circulating system can be formed in which the portion of the gas delivery line 32a located downstream of the main shutoff valve 33b and the gas delivery line 32b communicate with each other.

Therefore, by repeatedly sending the hydrogen gases to the fuel cell 25 to make them react with oxygen gases until hydrogen gas in the portion of the gas delivery line 32a located downstream of the main shutoff valve 33b and in the interior of the gas delivery line 32b is almost exhausted, the un-reacted hydrogen gas can be exhausted to generate electric power. Also, the connector 31a is positioned between the junction of the gas delivery line 32a with the gas delivery line 32b and the main shutoff valve 33b so that the hydrogen cylinder 31 can be selectively attached to and detached from the fuel cell 25. Because a portion of the hydrogen supply delivery line 32a located closer to the hydrogen cylinder 31 is closed by the shutoff valve 33b, hydrogen gas in the hydrogen cylinder 31 and said portion of the hydrogen supplying delivery line 32 proximal the hydrogen cylinder 31 is not released to the environment or to into the recirculation delivery line 32b.

Thus, even though the hydrogen gas within the hydrogen cylinder is not completely exhausted, the primary valve 33a and the main shutoff valve 33b can be closed at a proper and convenient time and the hydrogen cylinder 31 can be exchanged for new one. Hydrogen gas residing in the hydrogen cylinder 31 can be used together with the hydrogen gas newly charged into the hydrogen cylinder 31, while hydrogen gas residing in the portion of the gas delivery line 32a located downstream of the main shutoff valve 33b and in the interior of the gas delivery line 32b can be almost exhausted to generate electric power. As a result, hydrogen gas is not wasted. Also, the fuel cell system is convenient because the time for exchange of the hydrogen cylinder 31 can be planned in advance.

The gas delivery line 32b has a recirculation pump 34b to continuously supply the un-reacted hydrogen gas from the gas delivery line 32b to the fuel cell 25 through the gas delivery line 32a, so that the fuel cell 25 generates electric power. Thereby, the un-reacted hydrogen gas can be effectively circulated and not wasted. Power generation can thus be made more quickly and efficiently by using the unreacted hydrogen gas. Also, in the fuel cell system S, when the main switch is set to OFF, the opening and closing switch SW2 is set to OFF. Thus, the power supply to the drive motor 43 is stopped and the main shutoff valve 33b is closed so that electric power generated using the un-reacted hydrogen is used to charge the secondary battery 26.

Therefore, no hydrogen gas is newly supplied to the fuel cell 25 from the hydrogen cylinder 31, and the un-reacted hydrogen gas residing in the portion of the gas delivery line 32a located downstream of the main shutoff valve 33b and in the gas delivery line 32b is used to generate the electric power that is used to charge the secondary battery 26. The secondary battery 26 can therefore be charged without wasting the hydrogen gas. The electric power charged into the secondary battery 26 can be used as auxiliary power of the fuel cell 25 (e.g., can be used to supplement the power generated by the fuel cell 25 to operate the drive motor 43).

Also, the pressure sensor 34a is positioned in the portion of the gas delivery line 32a located downstream of the junction thereof with the gas delivery line 32b. When the pressure within the gas delivery line 32a measured by the pressure sensor 34a decreases below the threshold pressure amount, the operation of the recirculation pump 34b stops and the fuel cell 25 also stops generating electric power. Therefore, the fuel cell 25 continues to generate electric power until the hydrogen gas in the portion of the gas delivery line 32a located downstream of the main shutoff valve 33b and in the gas delivery line 32b becomes lower than the predetermined amount. Accordingly, hydrogen gas is not wasted and is used efficiently by the fuel cell system S. In addition, the recirculation pump 34b can be inhibited (e.g., stopped) from continuously operating after the hydrogen gas is exhausted.

In the fuel cell system S, the opening and closing switch SW1 that electrically connects and disconnects the fuel cell 25 and the secondary battery 26 is provided. When the operation of the recirculation pump 34b stops, the opening and closing switch SW1 is set to OFF to stop the power supply from the fuel cell 25 to the secondary battery 26. Thus, upon stopping the operation of the recirculation pump 34b, power generation by the fuel cell 25 can be stopped, and the charging of the secondary battery 26 can be stopped. In addition, because in one embodiment the fuel cell system S is provided for the motorcycle 10, the hydrogen cylinder 31 of the motorcycle 10 can be exchanged for a new one at a proper time without discharging the hydrogen gas in the hydrogen cylinder to the atmosphere even though the hydrogen gas within the hydrogen cylinder 31 may not be completely exhausted.

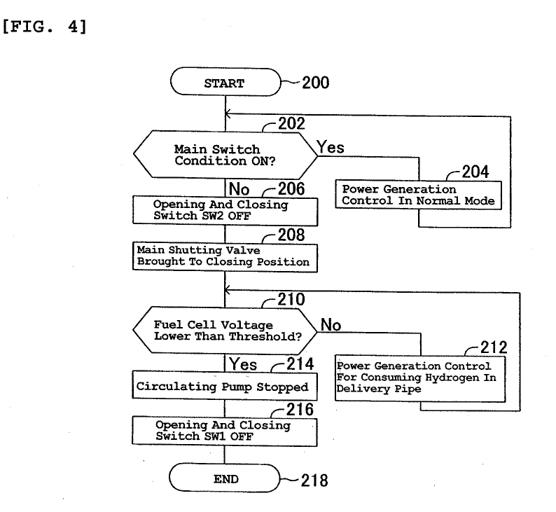

FIG. 4 shows another program for controlling power generation by the fuel cell 25, in accordance with another embodiment. This program can also be stored in the ROMs provided to the power supply system control device 50 and can be repeatedly executed at predetermined intervals by the CPU after the power switch is brought to the ON condition. At steps 200-208 and 212-218 in this program, the same processes are executed as in the processes of steps 100-108 and 112-118 in the program of FIG. 3 described above.

That is, in this embodiment, instead of determining whether the pressure of the hydrogen gas is lower than the preset threshold pressure (step 110 in the embodiment described above), a determination is made whether the voltage of the fuel cell 25 is lower than a predetermined threshold voltage (step 210). This threshold voltage amount can be previously set and stored in the RAMs. For example, the threshold voltage can be set to three volts. If the voltage of the fuel cell 25 is higher than the threshold voltage, and the determination “NO” is made in step 210, the program goes to step 212 to operate the fuel cell 25 to generate electric power.

The processes of steps 210, 212 are repeated and the fuel cell 25 continues to generate electric power until the voltage of the fuel cell 25 decreases below the threshold voltage amount and the determination “YES” is made at step 210. Under this condition, power generation by the fuel cell 25 uses the hydrogen gas residing in the portion of the gas delivery line 32a, which is closed by the main shutoff valve 33b, located downstream of the main shutoff valve 33b, and the hydrogen gas residing in the gas delivery line 32b. The electric power generated by the fuel cell 25 is used to charge the secondary battery 26. If the determination “YES” is made at step 210, the program goes to step 214. Hereunder, the processes of steps 214-218 that are executed are the same as those of steps 114-118 described above.

As thus described, according to this embodiment, when the voltage amount of the fuel cell 25 decreases below the threshold voltage, the recirculation pump 34b stops and power generation by the fuel cell 25 also stops. Operation of the fuel cell system S thus does not stop under a high voltage condition of the fuel cell 25. As a result, the fuel cell 25 can have a long life. Other actions and effects of this embodiment are the same as the actions and effects of the embodiment described above.

The fuel cell system is not limited to the embodiments described above and can be properly modified to be carried out. For example, in the embodiments described above, the fuel cell system S is mounted to the motorcycle 10. However, devices to which this fuel cell system is applied are not limited to the motorcycle 10 and can include vehicles such as, for example, a three-wheeled motored vehicle and a four-wheeled motored vehicle and devices other than vehicles that use electric power. Also, in the respective embodiments described above, power generation by the fuel cell 25 is stopped when the pressure of the hydrogen gas within the gas delivery line 32a decreases below the threshold pressure (e.g., atmospheric pressure) or when the voltage of the fuel cell 25 decreases below the threshold voltage (e.g., three volts). However, in another embodiment, cessation of power generation by the fuel cell 25 can occur when both the pressure in the gas delivery line 32a is lower than the threshold pressure and the voltage of the fuel cell 25 is below a threshold voltage.

According to the alternatives, the fuel cell 25 continues to generate electric power where a residual hydrogen gas amount in the gas delivery line 32a portion downstream of the main shutoff valve 33b and the gas delivery line 32b is larger than the predetermined amount even though a voltage amount of the fuel cell 25 decreases below the threshold voltage (e.g., three volts). Similarly, the fuel cell 25 continues to generate electric power where the voltage amount of the fuel cell 25 is higher than the threshold voltage amount although the pressure in the gas delivery line 32a decreases below the threshold pressure value. Therefore, waste of hydrogen gas can be inhibited, while extending the life of the fuel cell 25. The respective threshold pressure and voltage in the embodiments of the fuel cell system S can be set to amounts other than atmospheric pressure and three volts, respectively. In addition, other components forming the fuel cell system can be modified.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A fuel cell system comprising:
a fuel cell configured to react hydrogen gas with oxygen gas to generate electric power, the hydrogen gas supplied from a hydrogen cylinder through a hydrogen supply line;
an operating device configured to operate using electric power generated at least in part by the fuel cell;
a secondary power storage device operatively connected to the fuel cell, the secondary power storage device charged with electric power generated at least in part by the fuel cell;
a recirculation line coupled to the hydrogen supply line at a junction and coupled to the fuel cell, the recirculation line configured to return unreacted hydrogen gas discharged by the fuel cell back to the fuel cell via the hydrogen supply line;
a power supply system control device; and
a valve disposed upstream of the junction between the recirculation line and the hydrogen supply line, the valve being controlled by the power supply system control device and selectively moveable to an open position to allow flow of hydrogen gas from the hydrogen gas cylinder to the fuel cell, the valve further selectively moveable to a closed position to allow decoupling of the hydrogen cylinder from the hydrogen supply line, the recirculation line directing unreacted hydrogen gas therein to the fuel cell to exhaust said unreacted hydrogen gas and further generate electric power with the valve in the closed position.

2. The fuel system of claim 1, wherein the hydrogen cylinder is coupled to the hydrogen supply line via a coupling disposed between the junction and the valve

3. The fuel cell system of claim 1, wherein the recirculation line comprises a recirculation pump controlled by the power supply system control device to pump the unreacted hydrogen through the recirculation line to the fuel cell via the hydrogen supply line.

4. The fuel cell system of claim 1, further comprising:
a main ON-OFF switch arranged to operate the fuel cell in a normal mode; and
an operating device switch that selectively electrically connects and disconnects the fuel cell and the operating device, wherein the operating device switch is set to OFF and the valve is moved into the closed position when the main switch is in the OFF position so that electric power generated using the unreacted hydrogen supplied to the fuel cell is used to charge the secondary power storage device.

5. The fuel cell system according to claim 4 further comprising:
a voltage measuring device that measures a voltage of the fuel cell, wherein the power supply system control device stops the recirculation pump and stops the fuel cell from generating electric power after the main switch and the operating device switch are set to OFF, the secondary power storage device is charged with electric power generated using the hydrogen supplied to the fuel cell through the recirculation line and the measured fuel cell voltage decreases below a predetermined voltage threshold amount.

6. The fuel cell system of claim 5 further comprising:
a pressure measuring device positioned downstream of the junction between the hydrogen supply line and the recirculation line, wherein the power supply system control device stops the recirculation pump and stops the fuel cell from generating electric power after the main switch and the operating device switch are set to OFF, the secondary battery is charged with electric power generated using the hydrogen supplied to the fuel cell through the recirculation line and the measured hydrogen supply line pressure decreases below a predetermined pressure threshold amount.

7. The fuel cell system of claim 4 further comprising:
a pressure measuring device positioned downstream of the junction between the hydrogen supply line with the recirculation line, wherein the power supply system control device stops the recirculation pump and stops the fuel cell from generating electric power after the main switch and the operating device switch are set to OFF, the secondary battery is charged with electric power generated using the hydrogen supplied to the fuel cell through the recirculation line and the measured pressure within the hydrogen supply line decreases below a predetermined pressure threshold amount.

8. The fuel cell system of claim 5, further comprising:
a secondary power storage device switch that selectively electrically connects and disconnects the fuel cell and the secondary power storage device, wherein the power supply system control device sets the secondary power storage device switch to the OFF position when the recirculation pump is stopped and the fuel cell stops generating electric power used to charge the secondary power storage device.

9. An electric vehicle having the fuel cell system according to claim 1.

10. A fuel cell system comprising:
a fuel cell configured to react hydrogen gas with oxygen gas to generate electric power;
an electric motor configured to operate using electric power generated at least in part by the fuel cell;
a secondary power storage device electrically connected to the fuel cell and to the electric motor, the secondary power storage device charged with electric power generated at least in part by the fuel cell; and
means for inhibiting release of unreacted hydrogen gas when a hydrogen supply device operatively coupled to the fuel cell is decoupled therefrom.

11. The system of claim 10, wherein the fuel cell generates electric power using said unreacted hydrogen gas to charge the secondary power storage device.

12. A method for operating a fuel cell system having a fuel cell coupled to a secondary power storage device, the method comprising:
reacting hydrogen gas with oxygen gas within the fuel cell to generate electric power;
recirculating unreacted hydrogen gas discharged from the fuel cell back to the fuel cell to generate additional electric power; and
selectively isolating a hydrogen supply tank from the fuel cell to allow replacement of the tank while inhibiting release of unreacted hydrogen gas from the fuel cell system.

13. The method of claim 12, further comprising continuing to recirculate unreacted hydrogen gas back to the fuel cell following said isolation of the hydrogen tank so as to consume said unreacted hydrogen gas and inhibit a release thereof upon decoupling of the hydrogen supply tank from the fuel cell.

14. The method of claim 13, further comprising using the additional electric power generated from the unreacted hydrogen gas to charge a secondary power storage device.
